(19) United States
(12) Patent Application Publication
(10) Pub. No.: US 2008/0058454 A1
(43) Pub. Date: Mar. 6, 2008

(54) Chain-End Functionalized Fluoropolymers for the Preparation of Fluorpolymer/Clay Nanocomposites with Exfoliated Structure

(76) Inventor: Tze-Chiang Chung, State College, PA (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/740,437

(22) Filed: Apr. 26, 2007

Related U.S. Application Data
(60) Provisional application No. 60/795,455, filed on Apr. 27, 2006.

(51) Int. Cl. C08K 3/36

(52) U.S. Cl. 524/445

(57) ABSTRACT

An exfoliated fluoropolymer/clay nanocomposite characterized by a featureless X-ray diffraction pattern is detailed including a reaction product of a clay and a chain-end functionalized fluoropolymer. The chain-end functionalized fluoropolymer has the formula: X-(M)ₙ-Y (I), where M is one or more types of fluoromonomer unit; or a combination of one or more types of fluoromonomer unit and one or more types of hydrocarbon monomer unit. The variables X and Y are each independently H or a functional group capable of binding to the layered silicate clay, where at least one of X and Y is a functional group capable of binding to the layered silicate clay; and where n is an integer in the range of about 50 to 50,000, inclusive.

### REFERENCE TO RELATED APPLICATION

This application claims priority from U.S. Provisional Patent Application Ser. No. 60/7957455, filed Apr. 27, 2006, the entire content of which is incorporated herein by reference.

### GOVERNMENT SPONSORSHIP

This work was supported by the Office of Naval Research under Grant No. N00014-05-1-0287. Accordingly, the US government may have certain rights to this invention.

### FIELD OF THE INVENTION

This invention relates to chain-end functionalized fluropolymers, exfoliated fluropolymer/clay nanocomposites and processes for preparation thereof.

### BACKGROUND OF THE INVENTION

Although it has been long known that polymers can be mixed with appropriately modified clay minerals and synthetic clays, the field of polymer/clay nanocomposites has gained large momentum recently. Two major findings pioneered the revival of these materials: First, the report of a nylon-6/montmorillonite (mmt) material from Toyota research (Kojima, et al. J. Mater. Res. 1993, 8, 1179 and J. Polym Sci. Part A: Polym. Chem 1993, 31, 983), where very moderate inorganic loadings resulted in concurrent and remarkable enhancements of thermal and mechanical properties. Second, Giannelis et al. found that it is possible to melt-mix polymers with clays without the use of organic solvents (Giannelis, et al. Chem. Mater. 1993, 5, 1694). Since then, the high promise for industrial applications has motivated vigorous research, which revealed concurrent dramatic enhancements of many materials properties by the nano-dispersion of inorganic silicate layers. Where the property enhancements originate from the nano-composite structure, these improvements are generally applicable across a wide range of polymers. At the same time, there were also discovered property improvements in these nanoscale materials that could not be realized by conventional fillers, as for example simultaneously increasing tensile strength, flex modulus, and impact toughness, a general flame retardant characteristic (Gilman, et al. Chem. Mater. 2000, 12, 1866), and a dramatic improvement in barrier properties (Manias, et al. Macromolecules 2001, 34, 337).

Fluoropolymers, such as poly(tetrafluoroethylene) (PTFE), poly(vinylidine fluoride) (PVDF), poly(vinylidine-co-hexafluoropropene) (VDF/HFP elastomer), etc., exhibit an unique combination of properties, including thermal stability, chemical inertness (acid and oxidation resistance), low water and solvent absorptivities, self-extinguishing, excellent weatherability, and very interesting surface properties. They are commonly used in many high-end applications, such as aerospace, automotive, textile finishing, and microelectronics. However, fluoropolymers also have some drawbacks, including limited processibility, poor adhesion to substrates, limited crosslinking chemistry, and inertness to chemical modification, which limit their applications when interactive and reactive properties are paramount.

Fluoropolymers having both hydrophobic and oleophobic properties are the most difficult polymers to achieve good dispersion in clay/polymer composites. The pristine clays with highly hydrophilic property are immiscible with fluoropolymers, and there is no conceivable driving force to stabilize interfaces to form a thermodynamically stable exfoliated clay structure in a fluoropolymer matrix. The scientific challenge may have deterred some exploration to prepare fluoropolymer/clay nanocomposites, despite many potential advantages of such a unique material with the combination of physical properties from both materials.

Thus, there is a continuing need for fluoropolymer/clay nanocomposites and methods for their production.

### SUMMARY OF THE INVENTION

An exfoliated fluoropolymer/clay nanocomposite is provided which includes a reaction product of a layered silicate clay and a chain-end functionalized fluoropolymer. The chain-end functionalized fluoropolymer has the formula:
X-(M)ₙ-Y (I),
where M is one or more types of fluoromonomer unit; or a combination of one or more types of fluoromonomer unit and one or more types of hydrocarbon monomer unit. The variables X and Y are each independently H or a functional group capable of binding to the layered silicate clay, where at least one of X and Y is a functional group capable of binding to the layered silicate clay; and where n is an integer in the range of about 50 to 50,000, inclusive.

In specific embodiments, at least one of X and Y is Si(R)ₙ(OH)₃₋ₙ, Si(R)ₙ(OR)₃₋ₙ, OH, NH₂, COOH, an anhydride, an ammonium, an imidazolium, a sulfonium, or a phosphonium, where n is 0 to 2, and R is a C₁-C₆ alkyl group.

In a further provided embodiment of a nanocomposite according to the present invention, a neat polymer and/or an additive is included in an exfoliated fluoropolymer/clay nanocomposite.

An exfoliated fluoropolymer/clay nanocomposite is characterized by a featureless X-ray diffraction pattern in particular embodiments of the present invention.

In particular embodiments, a fluoromonomer unit included in the chain-end functionalized fluoropolymer includes a fluoromonomer unit selected from: vinyl fluoride (VF), vinylidine fluoride (VDF), trifluoroethylene (TrFE), tetrafluoroethylene (TFE), hexafluoropropene (HFP), 1-chloro-1-fluoro-ethylene(1,1-CFE), 1-chloro-2-fluoro-ethylene(1,2-CFE), 1-chloro-2,2-difluoroethylene (CDFE), chlorotrifluoroethylene (CTFE), a fluoroalkyl vinyl ether, a perfluoroalkyl vinyl ether, perfluoromethyl vinyl ether (PMVE), perfluoropropyl vinyl ether (PPVE), a fluoroacrylate, a perfluoroacrylate, a perfluoromethacrylate, 2,2,2-trifluoroethyl acrylate, and 2-(perfluorohexyl)ethyl acrylate. A fluoropolymer including combinations of fluoromonomer units is also contemplated.

A hydrocarbon monomer unit included in the chain-end functionalized fluoropolymer includes a carbon backbone of 2 to 15 carbon atoms, inclusive, in particular embodiments. For example, an exfoliated fluoropolymer/clay nanocomposite includes a vinyl chloride monomer unit, a vinyl ether monomer unit, an acrylate monomer unit or a methacrylate monomer unit. A chain-end functionalized fluoropolymer including combinations of hydrocarbon monomer units is also contemplated.

In preferred embodiments, the mole percentage of fluoromonomer units in the chain-end functionalized fluoropolymer is more than 20%.

In particular embodiments, the molecular weight of the chain-end functionalized fluoropolymer is in the range of about 1,000 and 1,000,000, inclusive. In preferred embodiments, a chain-end functionalized fluoropolymer has a molecular weight of at least 10,000.

An exfoliated fluoropolymer/clay nanocomposite is provided which includes a reaction product of a layered silicate clay and a chain-end functionalized fluoropolymer where the chain-end functionalized fluoropolymer includes a fluoromonomer selected from: vinyl fluoride (VF), vinylidine fluoride (VDF), trifluoroethylene (TrFE), tetrafluoroethylene (TFE), hexafluoropropene (HFP), 1-chloro-1-fluoro-ethylene(1,1-CFE), 1-chloro-2-fluoro-ethylene(1,2-CFE), 1-chloro-2,2-difluoroethylene (CDFE), chlorotrifluoroethylene (CTFE), and a combination thereof, where the chain end functionalized fluoropolymer has a molecular weight of at least 10,000.

An exfoliated fluoropolymer/clay nanocomposite according to a particular embodiment of the present invention includes a fluoropolymer having a molecular weight of at least 10,000 and including a perfluoroalkyl vinyl ether fluoromonomer. Examples of specific perfluoroalkyl vinyl ether fluoromonomers include, but are not limited to, perfluoromethyl vinyl ether (PMVE) and perfluoropropyl vinyl ether (PPVE).

A particular embodiment of an exfoliated fluropolymer/clay nanocomposite includes a fluoropolymer having a molecular weight of at least 10,000 and including a fluoroacrylate fluoromonomer, a perfluoroacrylate fluoromonomer, and/or a fluoromethacrylate fluoromonomer, such as 2,2,2-trifluoroethyl acrylate and 2-(perfluorohexyl)ethyl acrylate.

An exfoliated fluoropolymer/clay nanocomposite is provided which includes a reaction product of a layered silicate clay and a chain-end functionalized fluoropolymer where the chain-end functionalized fluoropolymer is a PVDF fluoropolymer having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a copolymer selected from the group consisting of: VDF/TFE and VDF/TrFE, the copolymer having a VDF content between about 1 and 50 mole %, inclusive, the fluoropolymer having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a VDF/TrFE copolymer having VDF content between about 1 and 50 mole %, inclusive, the fluoropolymer having at least one terminal functional group selected from the group consisting of: OH, Na⁺SO₄⁻, and Si(OR)₃, where R is a C₁-C6 alkyl group.

An exfoliated fluoropolymer/clay nanocomposite is provided which includes a reaction product of a layered silicate clay and a chain-end functionalized fluoropolymer where the chain-end functionalized fluoropolymer is a VDF/HFP fluoro-elastomer having HFP content between about 10-25 mole %, inclusive, the fluoro-elastomer having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a VDF/TFE/HFP fluoro-elastomer having TFE content between about 1 and 30 mole %, inclusive, HFP content between about 10-25 mole %, inclusive, the fluoro-elastomer having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a VDF/TrFE/CTFE terpolymer having TrFE content between about 10 and 50 mole %, inclusive, CTFE content between about 1-20 mole %, inclusive, the terpolymer having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a VDF/TrFE/CDFE terpolymer having TrFE content between about 10 and 50 mole %, inclusive, CDFE content between about 1-20 mole %, inclusive, the terpolymer having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a VDF/TrFE/CFE terpolymer having TrFE content between about 10 and 50 mole %, inclusive, CFE content between about 1-20 mole %, inclusive, and the terpolymer having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a poly(2,2,2-trifluoroethyl acrylate) having at least one terminal functional group selected from the group consisting of: OH, Na⁺SO₄⁻, and Si(OR)₃, where R is a C₁-C₆ alkyl group.

An exfoliated fluoropolymer/clay nanocomposite is provided which includes a reaction product of a layered silicate clay and a chain-end functionalized fluoropolymer where the chain-end functionalized fluoropolymer is a poly(2-perfluorohexyl ethyl acrylate) having at least one terminal functional group selected from the group consisting of: OH, Na⁺SO₄⁻, and Si(OR)₃, where R is a C₁-C₆ alkyl group.

A layered silicate clay included in embodiments of a nanocomposite of the present invention is selected from phyllosilicate clays, layered silicates, and layered fiber silicates, including montmorillonite, nontronite, beidellite, hectorite, saponite, sauconite, vermiculite, ledikite, magadiite, kenyaite, fluoromica, fluorohectorite, attapulgite, boehmite, imogolite, sepiolite, kaolinite, kadinite, and a synthetic equivalent thereof. In addition, combinations of two or more phyllosilicate clays, layered silicates, and layered fiber silicates may be included in an inventive nanocomposite.

Optionally, a layered silicate clay is treated to achieve a clay characterized by a desired property. For example, a layered silicate clay is treated to produce an organophilic clay or an acidic clay for use in an exfoliated fluoropolymer/clay nanocomposite.

Examples of additives optionally included in an exfoliated fluoropolymer/clay nanocomposite include a pigment, a stabilizer, a glass fiber, carbon black, and a combination thereof.

Particular embodiments of a nanocomposite of the present invention include a layered silicate clay present in an amount in the range of about 1 to 20 parts by weight of the total weight of the nanocomposite and include a chain end functionalized fluoropolymer present in an amount in the range of about 5 to 98 parts by weight of the total weight of the nanocomposite.

A neat polymer is optionally included in a nanocomposite according to the present invention, the neat polymer miscible with the chain end functionalized fluoropolymer. A neat polymer is present in an amount in the range of about 0.1 to 95, inclusive, parts by weight of the total weight of the nanocomposite.

A process for producing an exfoliated fluoropolymer/clay nanocomposite is provided according to the present invention which includes reacting a chain-end functionalized fluoropolymer and a layered silicate clay, producing an exfoliated fluoropolymer/clay nanocomposite. A melt process step and/or a solution process step may be used in a process to produce an exfoliated fluoropolymer/clay nanocomposite.

Further provided is an in situ process for producing an exfoliated fluoropolymer/clay nanocomposite. An inventive in situ process includes reacting a fluoromonomer, a functionalized radical initiator, and a layered silicate clay, thereby producing an exfoliated fluoropolymer/clay nanocomposite.

A process optionally further includes blending the exfoliated fluoropolymer/clay nanocomposite with a neat polymer to produce a ternary exfoliated fluoropolymer/clay nanocomposite. A further option includes blending the ternary exfoliated fluoropolymer/clay nanocomposite with an additive.

A chain-end functionalized fluoropolymer having the formula: X-(M)ₙ-Y, is provided by the present invention where M is one or more types of fluoromonomer unit, or a combination of one or more types of fluoromonomer unit and one or more types of hydrocarbon monomer unit. The variables X and Y are each independently H or a functional group capable of binding to the layered silicate clay, where at least one of X and Y is a functional group capable of binding to the layered silicate clay; and where n is an integer in the range of about 50 to 50,000, inclusive.

A process for preparing a chain-end functionalized fluoropolymer is described herein including reacting one or more fluoromonomer types and a functional radical initiator capable of adding a functional terminal group to the fluoropolymer, thereby producing a chain-end functionalized fluoropolymer having one or two functional terminal groups.

A further embodiment of a radical polymerization process for preparing a chain-end functionalized fluoropolymer is provided which includes reacting one or more fluoromonomer types in the presence of a radical initiator having a protected functional group suitable for polymerization. Typically, the radical initiator is capable of bonding to a polymer chain terminus. The radical initiator is further capable of being modified to add a functional group to a polymer chain terminus, thereby producing a fluoropolymer having a terminal functional moiety derived from the initiator.

### BRIEF DESCRIPTION OF THE DRAWINGS

FIG. 1 is an illustration of an exfoliated fluoropolymer/clay nanocomposite including a chain end functionalized fluoropolymer as an interfacial agent;

FIG. 2 shows X-ray diffraction patterns of (a) physical mixture of a triethoxysilane group terminated poly(vinylidene fluoride) polymer (PVDF-t-Si) and Na⁺-mmt (90/10 weight ratio), (b) the same mixture after static melt-intercalation, and (c) the 50/50 mixture by weight of exfoliated PVDF-t-Si/Na⁺-mmt structure (from b) and neat PVDF;

FIG. 3 shows X-ray diffraction patterns of a hydroxyl group terminated poly(2,2,2-trifluoroethyl acrylate) polymer (PTFEA-t-OH) and Na⁺-mmt powders (90/10 weight ratio) (a) physical mixture by simple powder mixing at ambient temperature and (b) the same mixture after static melt-intercalation (PTFEA-t-OH/mmt hybrid);

FIG. 4 shows X-ray diffraction patterns of two in situ prepared PVDF/Na⁺-mmt clay nanocomposite using (a) potassium persulfate and (b) benzoyl peroxide radical initiators.

FIG. 5 shows X-ray diffraction patterns of (a) in situ prepared PVDF/2C18-mmt clay nanocomposite using Na₂S₂O₈ initiator, (b) after further heating at 200° C. for 3 hours.

### DETAILED DESCRIPTION OF INVENTION

An exfoliated fluoropolymer/clay nanocomposite is provided according to the present invention which includes a reaction product of a layered silicate clay and a chain-end functionalized fluoropolymer. The chain-end functionalized fluoropolymer has the formula:
X-(M)ₙ-Y (I),
where M is one or more types of fluoromonomer unit; or a combination of one or more types of fluoromonomer unit and one or more types of hydrocarbon monomer unit. The variables X and Y are each independently H or a functional group capable of binding to the layered silicate clay, where at least one of X and Y is a functional group capable of binding to the layered silicate clay; and where n is an integer in the range of about 50 to 50,000, inclusive.

In specific embodiments, at least one of X and Y is Si(R)ₙ(OH)₃₋ₙ, Si(R)ₙ(OR)₃₋ₙ, OH, NH₂, COOH, an anhydride, an ammonium, an imidazolium, a sulfonium, or a phosphonium, where n is 0 to 2, and R is a C₁-C₆ alkyl group.

In a further provided embodiment of a nanocomposite according to the present invention, a neat polymer and/or an additive is included in an exfoliated fluropolymer/clay nanocomposite.

In a specific embodiment, the present invention provides exfoliated fluoropolymer/clay nanocomposites that show featureless X-ray diffraction (XRD) patterns.

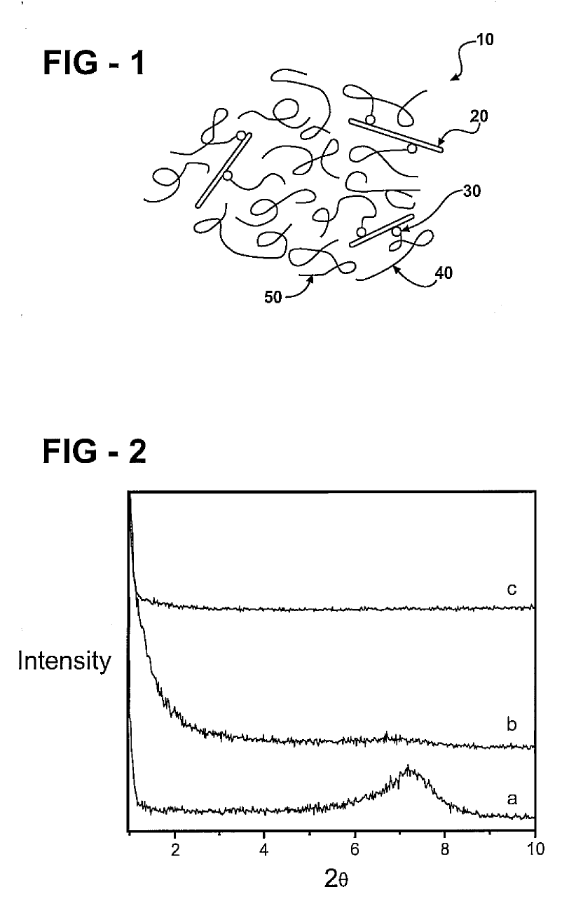

FIG. 1 illustrates an exfoliated fluoropolymer/clay nanocomposite 10 including a chain end functionalized fluoropolymer as an interfacial agent. A fluoropolymer 40 having a functionalized chain end interacts with a clay surface 20. A residue 30 of a reaction between the clay surface and the fluoropolymer terminal group anchors the fluoropolymer 40 to the clay surface. The hydrophobic and oleophobic fluoropolymer chain of the chain end functionalized fluoropolymer exfoliates the clay layer structure to form an inventive nanocomposite. This disordered clay structure is maintained even after optional further mixing with a neat polymer 50 that is compatible with the backbone of the chain end functionalized fluoropolymer.

The preparation of fluoropolymer/clay nanocomposites according to the present invention includes reaction of a chain end functionalized fluoropolymer serving as the clay/polymer interfacial compatibilizer, also termed a polymeric surfactant and interfacial agent herein, with a layered silicate clay.

One major advantage of a chain end functionalized fluoropolymer in the context of compositions and processes according to the present invention is that they exhibit very high surface activity on the silicate clay surfaces to exfoliate clay interlayer structure, even using pristine clay material, that is, clay without treatment with organic surfactants or acids. FIG. 1 illustrates the interaction pattern between a chain end functionalized fluoropolymer and the clay interlayer surfaces. The terminal functional group can anchor fluoropolymer chain to the clay surfaces between interlayers, either by chemical bond (such as Si—O—Si bond), strong interaction (such as hydrogen bonding and ion-ion interaction) or ion-exchange with cations (Li⁺, Na⁺, Ca²⁺, H⁺, etc.) located on the surfaces between the clay interlayers. The remaining unperturbed high molecular weight hydrophoblic and oleophobic fluoropolymer chain, disliking the hydrophilic clay surfaces, exfoliates the clay layer structure and maintains this disorder clay structure even after further mixing with neat (unfunctionalized) polymer that is compatible with the backbone of the chain end functionalized fluoropolymer.

An interfacial agent according to embodiments of the present invention is a chain end functionalized fluoropolymer containing a high molecular weight hydrophobic and oleophobic fluoropolymer chain and a terminal functional group. Such a terminal functional group illustratively includes Si(R)ₙ(OH)₃₋ₙ, Si(R)ₙ(OR)₃₋ₙ, OH, NH₂, COOH, anhydride, ammonium, immidazolium, sulfonium and phosphonium ions. Where a terminal functional group is Si(R)ₙ(OH)₃₋ₙ or Si(R)ₙ(OR)₃₋ₙ, n is from 0 to 2, and R is a C₁-C₆ alkyl group.

Chain end functionalized fluoropolymers provided according to embodiments of the present invention exhibit very high surface activities and allow formation of an exfoliated clay interlayer structure, even with pristine clay material, that is, clay material without pre-treatment with organic surfactants or acids.

A chain end functionalized fluoropolymer serving as the clay/polymer interfacial compatibilizer in methods and compositions of the present invention includes a single type of fluoromonomer polymerized to form a fluoropolymer in one embodiment. In further embodiments, a combination of two or more kinds of fluoromonomers is used to form a fluoropolymer. Thus, for example, a mixture of two or more fluoromonomers, or a mixture of at least one fluoromonomer and at least one hydrocarbon monomer may be used to form a chain end functionalized fluoropolymer.

The preferred fluoromonomer units are selected from vinyl fluoride (VF), vinylidine fluoride (VDF), trifluoroethylene (TrFE), tetrafluoroethylene (TFE), hexafluoropropene (HFP), 1-chloro-1-fluoro-ethylene(1,1-CFE), 1-chloro-2-fluoro-ethylene(1,2-CFE), 1-chloro-2,2-difluoroethylene (CDFE), chlorotrifluoroethylene (CTFE), perfluoroalkyl vinyl ethers, such as perfluoromethyl vinyl ether (PMVE) and perfluoropropyl vinyl ether (PPVE), and perfluoro acrylates and methacrylates, such as 2,2,2-trifluoroethyl acrylate (TFEA) and 2-(perfluorohexyl)ethyl acrylate.

A hydrocarbon monomer included in a chain end functionalized fluoropolymer preferably includes from 2 to 15 carbon atoms. Preferred hydrocarbon monomer units are selected from vinyl chloride, vinyl ether, acrylates and methacrylates.

The mole percentage of fluoromonomer units included in a chain end functionalized fluoropolymer serving as the clay/polymer interfacial compatibilizer is more than 20% in preferred embodiments.

The molecular weight of a chain end functionalized fluoropolymer serving as the clay/polymer interfacial compatibilizer is in the range between about 1,000 and 1,000,000, inclusive. A preferred molecular weight of a chain end functionalized fluoropolymer is in the range between about 5,000 and 300,000, inclusive. A most preferred range for the molecular weight of a chain end functionalized fluoropolymer is in the range between about 10,000 and 200,000, inclusive.

A chain end functionalized fluoropolymer included in methods and compositions according to the present invention includes a chain of atoms which are collectively referred to as a “backbone.” In general, the backbone is a carbon backbone. However, in particular embodiments, the backbone includes one or more heteroatoms such as N, S, O or P. The backbone is typically linear but is optionally branched. One or more groups pendant from the backbone is optionally present.

The backbone of a linear fluoropolymer has two termini. A functional terminal group is present on at least one terminus of the backbone of a linear fluoropolymer which is a chain-end functionalized fluoropolymer. Where two functional terminal groups are present at termini of a linear fluoropolymer, the groups may be the same or different.

In a further embodiment, a fluoropolymer is non-linear, such as a branched fluoropolymer, and thus has more than two termini. A functional terminal group is present on at least one terminus of the backbone of a non-linear fluoropolymer which is a chain-end functionalized fluoropolymer. Where two or more functional terminal groups are present at termini of a non-linear fluoropolymer, the groups may be the same or different.

At least one of the termnini of the backbone includes a functional group capable of interaction with a clay. Thus, a chain end functionalized fluoropolymer according to the invention has unique surface activity on clay interfaces. A terminal functional group of a chain-end functionalized fluoropolymer, is capable of strong interaction with clay, and anchors the polymer chain to the surfaces between the clay interlayers. For example, such interactions include chemical bonding, strong physical interaction, such as hydrogen bonding and ion-ion interaction, and/or ion-exchange with cations, including but not limited to Li⁺, Na⁺, Ca²⁺, and H⁺, located between the clay interlayers.

A terminal functional group included in a chain end functionalized fluoropolymer is illustratively Si(R)ₙ(OH)₃₋ₙ, Si(R)ₙ(OR)₃₋ₙ, OH, NH₂, COOH, anhydride; or an ammonium, imidazolium, sulfonium, or phosphonium ion. Where a terminal functional group is Si(R)ₙ(OH)₃₋ₙ or Si(R)ₙ(OR)₃₋ₙ, n is from 0 to 2, and R is a C₁-C₆ alkyl group in particular embodiments.

Layered Silicate Clays

The term “clay” is well known in the nanocomposite art and includes phyllosilicate clays, layered silicates, and layered fiber silicates. Illustrative of such materials are the clay minerals including, but not limited to, montmorillonite, nontronite, beidellite, hectorite, saponite, sauconite, vermiculite, ledikite, magadiite, kenyaite, fluoromica, fluorohectorite, attapulgite, boehmite, imogolite, sepiolite, kaolinite, kadinite and their synthetic equivalents.

In particular preferred embodiments, phyllosilicates are included which contain multi-layered 2:1 silicates having negative charge centers on the layers ranging from 0.25 to 1.5 charge centers per formula unit and a commensurate number of exchangeable cations in the interlayer spaces.

In further preferred embodiments, an included clay mineral is a smectite clay mineral, such as montmorillonite (mmt), that is a naturally occurring 2:1 phyllosilicate, which has the same layered and crystalline structure as talc and mica but a different layer charge. The mmt crystal lattice consists of 1 nm thin layers, with a central octahedral sheet of alumina fused between two external silica tetrahedral sheets in such a way that the oxygen atoms from the octahedral sheet also belong to the silica tetrahedra. These layers organize themselves in a parallel fashion to form stacks with a regular van der Waals gap between them, called interlayer or gallery.

In their pristine form the excess negative charge of such minerals is balanced by cations, such as Na⁺, Li⁺ and Ca²⁺, which exist hydrated in the interlayer. The cations can be easily exchanged to proton (H⁺) by acid-treatment to form acidic clay. For example, a clay may be treated with HCl to exchange protons for other cations, producing an acidic clay.

In further embodiments, a clay is treated to produce an organophilic clay, that is, a clay miscible with a hydrophobic polymer. To render a clay, such as montmorillonite, miscible with hydrophobic (non-polar) polymers, a general approach is to exchange the alkali counterions with cationic-organic surfactants, such as alkylammoniums, to form organophilic clay. A particular commercially available clay is dioctadecylammonium-modified montmorillonite (2C18-mmt).

Preparation of an Exfoliated Fluoropolymer/Clay Nanocomposite

A process for producing an exfoliated fluoropolymer/clay nanocomposite is provided according to the present invention which includes reacting a chain-end functionalized fluoropolymer and a layered silicate clay, producing an exfoliated fluoropolymer/clay nanocomposite.

Reacting a chain-end functionalized fluoropolymer and a layered silicate clay to produce an exfoliated fluoropolymer/clay nanocomposite is achieved by methods including in situ polymerization, solution blending and/or melt blending.

All the methods are aimed to achieve single layer dispersion of the layered silicate in the polymer matrix, because high surface area is directly associated with the enhanced properties in polymer/clay nanocomposites.

In Situ Process for Formation of a Binary Fluoropolymer/Clay Nanocomposite

For the in situ polymerization method, an initiator or catalyst is usually pre-fixed inside the clay interlayer via cationic exchange, then the layered silicate is swollen by monomer solution. The polymerization occurs in situ to form the polymer right between the interlayers with intercalated or/and exfoliated structures. General aspects of in situ polymerization methods are described in Usuki, et al. J. Mater. Res. 1993, 8, 1179, Lan, et al. J. Chem. Mater. 1994, 6, 2216, Zhao, et al. J. Polym. Sci.: Part A: Polym. Chem. 2004, 42, 916, Chen, et al. Polymeric Materials: Science and Engineering 2004, 91, 605.

The instant invention discloses a new in situ process to prepare chain end functionalized fluoropolymers that firmly anchor onto clay surfaces between interlayers and exfoliate clay interlayer structure during the polymerization. In particular, an inventive in situ process includes reacting a fluoromonomer, a functionalized radical initiator, and a layered silicate clay, thereby producing an exfoliated fluoropolymer/clay nanocomposite.

The chemistry involves functional radical initiators that contain a functional group, such as OH, Na⁺SO₄⁻, and Si(OR)₃, wherein R is a C₁-C₆ alkyl group, which can anchor initiator onto the clay surface by hydrogen bonding, ion-exchange with cations (Li⁺, Na⁺, etc.) on the clay interface, and Si—O—Si chemical bond, respectively. With the presence of fluoromonomers, the immobilized initiator initiates the polymerization from the interface, and the functional group becomes the beginning end of the fluoropolymer chain that is firmly anchored onto the surface in clay interlayers. The growing hydrophoblic and oleophobic fluoropolymer chain dislikes the hydrophilic clay surfaces and exfoliates the clay layer structure during the polymerization. In other words, the use of functional radical initiator allows one step polymerization to prepare fluoropolymer/clay nanocomposites. Specific examples of initiators and in situ processes for formation of a binary fluoropolymer/clay nanocomposite are described herein.

Melt and Solution Processes to Form Exfoliated Fluoropolymer/Clay Nanocomposites

In another embodiment, this instant invention discloses melt and solution processes to prepare the exfoliated fluoropolymer/clay nanocomposites.

In the solution blending, the layered silicates (modified with organic surfactants) are dispersed in an appropriate solvent before dissolving the polymer in the same solvent. When the solvent is evaporated, or the mixture precipitated, the sheets try to reassemble, kinetically trapping the polymer between them to form a nanocomposite structure. General aspects of solution blending are described in Jeon, et al, Polymer Bulletin 1998, 41, 107.

In the melt blending process, the layered silicate is mixed with the polymer matrix in the molten state. If the layer surfaces are sufficiently compatible with the chosen polymer, the polymer enters into the interlayer space and forms either an intercalated or an exfoliated nanocomposite. No solvent is required in this technique making it a desirable industrial method. General aspects of melt blending are described in Giannelis, E. Adv. Mater. 1996, 8, 29.

It should be understood that embodiments of an inventive process include binary and ternary blends. For example, in an embodiment of a binary blend, two components, a chain end functionalized fluoropolymer and a silicate clay are blended together and reacted. In an embodiment of a ternary blend, three components, a chain end functionalized fluoropolymer, a silicate clay and a neat polymer are blended together and reacted.

Additional embodiments include pre-mixing of two components before adding a third component. For example, a chain end functionalized fluoropolymer may be pre-mixed with a silicate clay (with or without treatment of organic surfactants or acid reagents) to form an exfoliated material and then blended with a neat polymer that is compatible with the backbone of the chain end functionalized fluoropolymer.

Alternatively, the exfoliated material can be prepared by in situ polymerization process prior to optional blending with a neat polymer.

In addition, a process according to the present invention also optionally includes mixed solution and/or melt blending steps. For example, solution blending is firstly employed between chain end functionalized fluoropolymer and silicate clay to form a binary blend, and then melt blending is used to mix the binary blend with the corresponding neat fluoropolymer.

It is appreciated that both the exfoliated binary or ternary fluoropolymer/clay nanocomposite blends can be further mixed with one or more additives, such as pigment, stabilizer, glass fibers, etc.

An inventive exfoliated clay structure maintains its disordered exfoliated state even after further mixing with neat, unfunctionalized, polymer. For example, an exfoliated fluoropolymer/clay nanocomposite may be mixed with an unfunctionalized polymer that is compatible with the backbone of the chain end functionalized fluoropolymer without disrupting the exfoliated structure of the fluoropolymer/clay nanocomposite.

A neat polymer included in an embodiment of a composition and process according to the present invention is a regular (unfunctionalized) polymer that is miscible with a chain end functionalized fluoropolymer. A neat polymer is usually prepared by free radical polymerization of single or multiple vinyl monomers, such as vinyl fluoride (VF), vinylidine fluoride (VDF), trifluoroethylene (TrFE), tetrafluoroethylene (TFE), hexafluoropropene REP), 1-chloro-1-fluoro-ethylene(1,1-CFE), 1-chloro-2-fluoro-ethylene(1,2-CFE), 1-chloro-2,2-difluoroethylene (CDFE), chlorotrifluoroethylene (CTFE), perfluoromethyl vinyl ether (PMVE) and perfluoropropyl vinyl ether (PPVE), 2,2,2-trifluoroethyl acrylate, 2-(perfluorohexyl)ethyl acrylate, acrylates, and methacrylates. A preferred molecular weight of a neat polymer included in a composition according to the present invention is preferably between about 20,000 to 1,000,000 g/mole, inclusive. A most preferred molecular weight of a neat polymer included in a composition according to the present invention is preferably between about 40,000 to 200,000 g/mole, inclusive.

A nanocomposite of the present invention including 1) a reaction product of a chain end functionalized fluoropolymer and a layered silicate clay processes and 2) a neat polymer is formed by a process including (i) in situ polymerization, (ii) solution blending, and/or (iii) melt blending, to prepare an exfoliated fluoropolymer/clay nanocomposite that exhibits featureless X-ray diffraction (XRD) patterns.

A particular embodiment of a process according to the present invention includes a combination of in situ polymerization and blending. For example, in situ polymerization of a fluoromonomer in the presence of clay yields an exfoliated fluoropolymer/clay nanocomposite which is further mixed with a compatible polymer by blending resulting in an exfoliated fluoropolymer/clay nanocomposite in a polymer matrix. Advantageously, a process according to the present invention yields an exfoliated fluoropolymer/clay nanocomposite which maintains an exfoliated structure even after blending with the polymer.

In additional embodiments, an additive is included in a nanocomposite. Exemplary additives include, but are not limited to, a pigment, a dye, a stabilizer, a filler, an antioxidant, a viscosity modifier, a releasing agent, and an electrical conductivity modifier. A specific example of a filler is glass fibers and a specific example of an additive which is both a filler and a pigment is carbon black. An additive is included in a nanocomposite by any of various methods, including using multi-component blending by further melt or solution mixing of the nanocomposite components. For example, an additive is optionally added during in-situ polymerization in a process to form a nanocomposite according to the present invention. In further embodiments, an additive is added during formation of a ternary nanocomposite, such as during solution blending and/or melt blending of a polymer and an exfoliated fluoropolymer/clay nanocomposite.

In a specific embodiment, a composition of fluoropolymer/clay nanocomposite includes (a) 5 to 98 parts by weight of the chain end functionalized fluoropolymer, (b) 0 to 95 parts by weight of a corresponding neat polymer that is compatible with the backbone of the chain end functionalized fluoropolymer, and (c) from 1 to 20 parts by weight of clay material, with or without organic surfactant, and/or acidic clays.

Featureless XRD

X-ray diffraction (XRD) measurements are commonly used to characterize the morphology of polymer/clay nanocomposite materials. Clay with layered (ordered) structure shows (001) d spacing peaks in the low angle region, and the angle decreases with the increase of d spacing. If diffraction peaks in a polymer/clay nanocomposite are observed in the lower angles than those of clay, which indicate the (001) d spacing (basal spacing) of ordered-intercalated nanocomposite. As expected, if the nanocomposites are completely disordered (exfoliated), no peaks are observed in the XRD, due to loss of the parallel registry of the layers. This lack of peaks is referred to as a “featureless XRD” herein. On the other hand, the observation of a strong intercalated XRD peak in the nanocomposite does not guarantee the absence of exfoliated layers.

Experimentally, it is very common in polymer/clay nanocomposites to have a mixed nano-morphology, with both intercalated and exfoliated structures existing in the system. Intercalated structures are self-assembled, well-ordered multilayered structures where the extended polymer chains are inserted into the gallery space between parallel individual silicate layers separated by 2-3 nm. In contrast, an exfoliated structure results when the individual silicate layers are no longer close enough to interact with each other. In the exfoliated cases the interlayer distances can be on the order of the radius of gyration of the polymer; therefore, the silicate layers may be considered to be well-dispersed in the organic polymer. The silicate layers in an exfoliated structure are typically not as well-ordered as in an intercalated structure, although in many cases the exfoliated structures still bear previous parallel registry.

Preparation of a Chain End Functionalized Fluoropolymer

A chain-end functionalized fluoropolymer is prepared by various methods, including, but not limited to, preferred methods described herein in detail.

In particular methods of preparing a chain-end functionalized fluoropolymer, new radical initiators that are relatively stable and can initiate living radical polymerization at ambient temperature developed as described in Chung, et. al, U.S. Pat. Nos. 5,286,800 and 5,401,805; Macromolecules, 26, 3467, 1993; Macromolecules, 31, 5943, 1998; J. Am. Chem. Soc., 121, 6763, 1999 are used. Additionally, several relatively stable radical initiators, which exhibit living radical polymerization characteristics with a linear relationship between polymer molecular weight and monomer conversion and producing block copolymers by sequential monomer addition are described in Chung, et. al, U.S. Pat. Nos. 6,420,502; 6,515,088, and J. Am. Chem. Soc., 118, 705, 1996 and these initiators may be used. This stable radical initiator system may be used in a process for polymerization of fluorinated monomers, which can effectively occur in bulk and solution conditions, such as in a process according to the present invention. Some interesting ferroelectric fluoro-terpolymers described in Chung et al, U.S. Pat. No. 6,355,749 and Macromolecules 35, 7678, 2002 have been prepared with high molecular weight and controlled polymer structure with narrow molecular weight and composition distributions which may also be used in an inventive method.

In particular embodiments of the present invention, a chain end functionalized fluoropolymer is prepared using a functional borane initiator in a process of radical polymerization. In such an embodiment, a fragment of the initiator containing a functional group(s) is added at a terminus of a polymer chain. One example is illustrated in Equation 1.

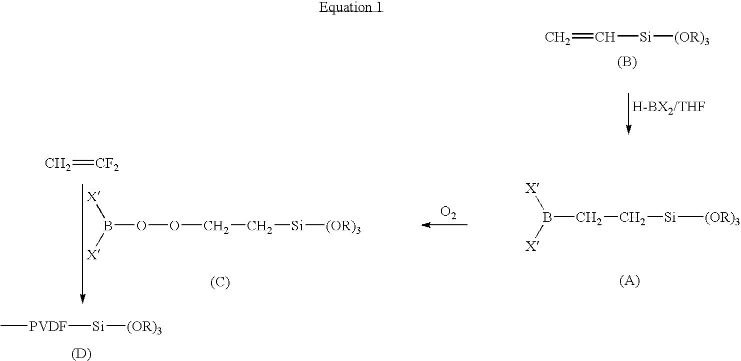

In Equation 1 X′ is hydrogen, halide, or alkyl group with C₁-C₁₀ group, and R is a C₁-C₆ alkyl group. The functional borane initiator (A), containing a silane group, is prepared by hydroboration reaction of vinylsilane (B) with a borane compound containing at least one B—H group. Vinylsilane is commercially available. The hydroboration reaction is almost quantitative at ambient temperature. The subsequent mono-oxidation reaction of functional borane initiator (A) with a control quantity of oxygen spontaneously occurs at room temperature to form the corresponding peroxylborane (C) containing a reactive B—O—O—C moiety for initiating polymerization. This oxidation reaction can be carried out in situ during the polymerization with the presence of monomers.

Without being bound by any theory, it is believed that in the presence of suitable monomers, the B—O—O—C species (C) that is formed further decomposes at ambient temperature to an alkoxyl radical (C—O*) and a borinate radical (B—O*). The alkoxyl radical is believed active in initiating polymerization of monomers. On the other hand, the borinate radical (B—O*) is believed too stable to initiate polymerization due to the back-donating of electrons to the empty p-orbital of boron. However, this “dormant” borinate radical may form a reversible bond with the radical at the growing chain end to prolong the lifetime of the propagating radical. The resulting fluoropolymers (D) has a terminal silane group at the beginning of polymer chain, and the polymer molecular weight is controlled by monomer concentration and reaction time. Under some reaction conditions, especially at high reaction temperatures, the termination by coupling reaction is enhanced, and the resulting polymer contains two terminal silane groups at the beginning and at the end of polymer chain.

The specific acid-base interaction between boron in the initiator and fluorine in the monomer significantly enhances the addition reaction of a fluoromonomer to the propagating site. Departing from many free radical polymerization systems, this borane-mediated radical polymerization can take place at ambient temperature to incorporate a broad range of fluoromonomers, including vinyl fluoride (VF), vinylidine fluoride (VDF), trifluoroethylene (TrFE), tetrafluoroethylene (TFE), hexafluoropropene (HFP), 1-chloro-1-fluoro-ethylene(1,1-CFE), 1-chloro-2-fluoro-ethylene(1,2-CFE), 1-chloro-2,2-difluoroethylene (CDFE), chlorotrifluoroethylene (CTFE), perfluoroalkyl vinyl ethers, perfluoro acrylates and methacrylates, and their mixtures.

Another type of functional borane initiator suitable for use in a process according to the present invention includes cycloborane molecules, such as 8-boraindane, 9-boradecalin, and 1-boraadamantane, in which all three C—B bonds are part of the cyclic structure. Equation 2 illustrates the preparation of a chain end functionalized acrylic fluoropolymer by using an 8-boraindane initiator (E). The resulting polymer chain contains two terminal OH groups in the beginning of polymer chain (H), where n is the number of repeat units.

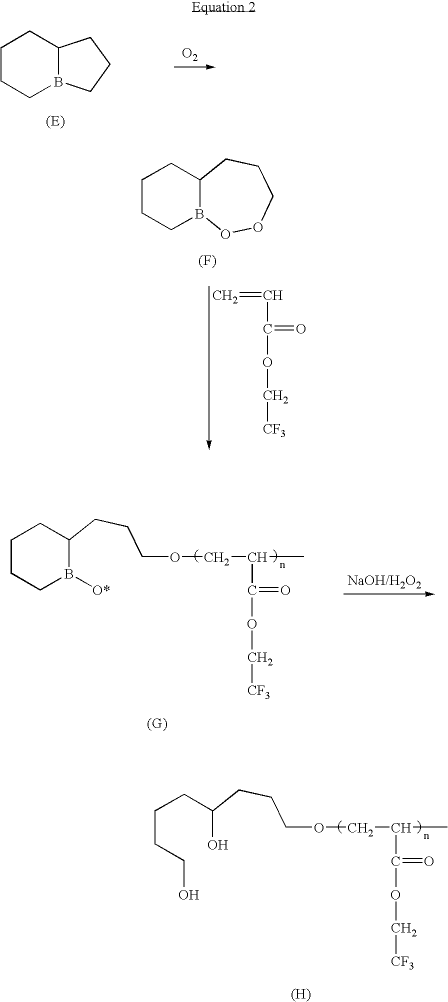

In this 8-boraindane (E) case, one of three cyclic B—C bonds is oxidized and initiates control radical polymerization of 2,2,2-trifluoroethylacrylate (TFEA), and the partially oxidized cycloborane residue remains bonded to the beginning of polymer chain (G), despite the continuous growth of the polymer chain. After terminating the control radical polymerization, the two unreacted cyclic B—C bonds in the borane residue can be completely interconverted to functional groups, such as two OH groups by NaOH/H₂O₂ reagent. The resulting poly(2,2,2-trifluoroethylacrylate) (H) has two OH groups located at the beginning of polymer chain, as well as having a controlled molecular weight and narrow molecular weight distribution. The chemistry is applicable to many acrylate and methacrylate monomers, including fluorinated and unfluorinated ones and their mixtures.

In addition to homoploymers and random copolymers, it is also possible to extend the functional borane-mediated control radical polymerization to block copolymers by means of sequential monomer addition. In other words, after completing the polymerization of a first monomer to the extent desired to form a first polymer “block”, a second monomer is introduced into the reaction mass to effect polymerization of the second monomer to form a second polymer “block” that is attached to the end of the first block. Thus, monomers included to form a fluropolymer included in structure (I) may be a mixture of two or more fluoromonomers, or a mixture of at least one fluoromonomer and at least one hydrocarbon monomer. A hydrocarbon monomer used to form a fluoropolymer preferably includes from 2 to 15 carbon atoms. After terminating the living polymerization, the partially oxidized borane residue located at the beginning of polymer chain can be completely interconverted to reactive functional end groups. Using this sequential addition process, a broad range of copolymers, illustratively including, but not limited to, multiblock copolymers such as diblock and/or triblock copolymers, can be prepared, which contain reactive terminal functional group(s) at the same polymer chain end.

Embodiments of inventive compositions and methods are illustrated in the following examples. These examples are provided for illustrative purposes and are not considered limitations on the scope of inventive compositions and methods.

### EXAMPLES

### Example 1

### Synthesis of [C₂H₅OSi(CH₃)₂CH₂CH₂CH₂]₃B Functional Initiator

In a 1000 ml flame-dried flask equipped with a magnetic stir bar, 250 ml of dry ether and 37 g (250 mmol) of diethoxyldimethylsilane were injected under argon. The solution was vigorously stirred while 250 ml of allylmagnesiumbromide in ether (1.0 M) was added dropwise over 2 hours. The solution was refluxed overnight to complete the coupling reaction. After cooling the mixture to −20° C. and removing the solid by filtration, the solvent was removed by rovaperation. The raw product was subjected to vacuum distillation to obtain 30 g of pure allylethoxyldimethylsilane (colorless liquid) with yield of 84%.

In a 500 ml flamed-dried flask equipped with a magnetic stir bar, 250 ml of dry ether and 30 g (210 mmol) of allylethoxyldimethylsilane was injected into the flask. After the solution was cooled down to 0° C., 70 ml of BH₃ in THF (1.0 M) was added. The mixture was then stirred at 0° C. for 4 hours before warming up to ambient temperature for another 1 hour. After removing solvent by vacuum, 22.3 g of tri-3-(dimethylethoxylsilyl)propylborane functional initiator (with 71% yield) was obtained by distillation at 150° C.˜160° C. under high vacuum.

### Example 2

### Synthesis of [(C₂H₅O)₃SiCH₂CH₂]₃B Functional Initiator

Following similar procedure described in Example 1, 250 ml of dry THF and 35 g (180 mmol) of vinyltriethoxylsilane was injected into a 500 ml dry flask equipped with a magnetic stir bar. After cooling the solution to 0° C., 60 ml of BH₃ in THF (1.0 M) was added. The mixture was stirred at 0° C. for 4 hours and then was warmed to ambient temperature for 1 hour to assure complete hydroboration reaction. After solvent-removal, the product was subjected to vacuum distillation at 170° C. to obtain 23.4 g of tri-3-(dimethylethoxylsilyl)propylborane.

### Examples 3-10

### Synthesis of PVDF Polymers Containing A Terminal C₂H₅OSi(CH₃)₂ Group

A series of C₂H₅OSi(CH₃)₂ group terminated PVDF polymers were prepared by using [C₂H₅OSi(CH3)₂CH₂CH₂CH₂]₃B functional initiator (obtained from Example 1). The experimental conditions and results are summarized in Table 1. All reactions were carried out in a Parr high pressure reactor (200 ml) equipped with a magnetic stir bar. In a typical reaction (Example 7), 2.3 g of [C₂H₅OSi(CH₃)₂CH₂CH₂CH₂]₃B (5 mmol) was dissolved in 100 ml of CH₂Cl₂ in a dry box, the reactor was then connected to a vacuum line, and 25.6 g (400 mmol) of VDF was condensed under vacuum by liquid nitrogen. About 2.5 mmol O₂ was charged into the reactor to oxidize borane moiety and initiate the polymerization that was carried out at ambient temperature for 4 hours. After releasing the pressure, the mixture was transferred into a flask containing 100 ml of hexane. After stirring for 30 min, the polymer powder was filtered, washed, and dried under vacuum at 60° C. for 6 hours. About 19 g of polymer was obtained.

TABLE 1
Summary of PVDF Polymers Containing
A Terminal C₂H₅OSi(CH₃)₂ Group Prepared by
[C₂H₅OSi(CH₃)₂CH₂CH₂CH₂]₃B/O₂ Initiator

| Ex. | B (mmol) | O₂ (mmol) | VDF (mmol) | Yield (%) | Remark |
|---|---|---|---|---|---|
| 3 | 1.0 | 0.5 | 400 | 10 | White powder |
| 4 | 2.0 | 1.0 | 400 | 16 | White powder |
| 5 | 5.0 | 1.0 | 400 | 18 | Whiter powder |
| 6 | 5.0 | 2.0 | 400 | 47 | Whiter powder |
| 7 | 5.0 | 2.5 | 400 | 74 | Whiter powder |
| 8 | 5.0 | 3.0 | 400 | 86 | Whiter powder |
| 9 | 5.0 | 5.0 | 400 | 81 | Whiter powder |
| 10 | 10.0 | 5.0 | 400 | 85 | Whiter powder |

### Examples 11-16

### Synthesis of PVDF Polymers Containing A Terminal (C₂H5O)₃Si Group

A series of (C₂H₅O)₃Si Group terminated PVDF polymers were prepared by using [(C₂H₅O)₃SiCH₂CH₂]₃B functional initiator (obtained from Example 2). Table 2 summarizes the experimental conditions and results. All polymerization reactions were carried out in a Parr high pressure reactor (200 ml) equipped with a magnetic stir bar. In a typical reaction, 2.9 g of [(C₂H₅O)₃SiCH₂CH₂]₃B (5 mmol) was dissolved in 100 ml of CH₂Cl₂ in a dry box, the reactor was then connected to a vacuum line, and 25.6 g of VDF (400 mmol) was condensed under vacuum by liquid nitrogen. About 2.5 mmol O₂ was charged into the reactor to oxidize borane moiety and initiate the polymerization that was carried out at ambient temperature for 4 hours. After releasing the pressure, the mixture was transferred into a flask containing 100 ml of hexane. After stirring for 30 min, the polymer powder was filtered, washed, and then dried under vacuum at 60° C. for 6 hours. About 21 g of polymer was obtained with yield of 82%.

TABLE 2
Summary of PVDF Polymers Containing A Terminal (C₂H₅)₃OSi
Group Prepared by [(C₂H₅O)₃SiCH₂CH₂]₃B/O₂ Initiator

| Ex. | B (mmol) | O₂ (mmol) | VDF (mmol) | Yield (%) | Remark |
|---|---|---|---|---|---|
| 11 | 1.0 | 0.5 | 400 | 12 | Whiter powder |
| 12 | 2.0 | 1.0 | 400 | 23 | Whiter powder |
| 13 | 5.0 | 1.0 | 400 | 32 | Whiter powder |
| 14 | 5.0 | 2.5 | 400 | 82 | Whiter powder |
| 15 | 5.0 | 5.0 | 400 | 73 | Whiter powder |
| 16 | 10.0 | 5.0 | 400 | 86 | Whiter powder |

### Examples 17-20

### Synthesis of VDF/HFP Copolymers Containing A Terminal C₂H₅OSi(CH₃)₂ Group

A series of C₂H₅OSi(CH₃)₂ group terminated VDF/HFP copolymers were prepared by using [C₂H₅OSi(CH₃)₂CH₂CH₂CH₂]₃B functional initiator (obtained from Example 1). The experimental conditions and results are summarized in Table 3. All reactions were carried out in a Parr high pressure reactor (200 ml) equipped with a magnetic stir bar. In a typical reaction, 4.6 g of [C₂H₅OSi(CH₃)₂CH₂CH₂CH₂]₃B (10 mmol) was dissolved in 80 ml of CH₂Cl₂ in a dry box, the reactor was then connected to a vacuum line, and 25.6 g of VDF (400 mmol) and 60 g of HFP (400 mmol) was condensed under vacuum by liquid nitrogen. About 5 mmol O₂ was charged into the reactor to oxidize borane moiety and initiate the polymerization that was carried out at 60° C. for 10 hours. After releasing the pressure, the mixture was transferred into a flask containing 100 ml of hexane. After stirring for 30 min, the polymer powder was filtered, washed, and dried under vacuum at 60° C. for 6 hours. About 21 g of polymer was obtained with yield of 26%. The polymer structure was confirmed by ¹H and ¹⁹F NMR spectra.

TABLE 3
Summary of VDF/HFP Copolymers Containing A
Terminal C₂H₅OSi(CH₃)₂
Group Prepared by [C₂H₅OSi(CH₃)₂CH₂CH₂CH₂]₃B/O₂ Initiator

| | B | O₂ | VDF | HFP | Yield | HFP | |
|---|---|---|---|---|---|---|---|
| Ex. | (mmol) | (mmol) | (mmol) | (mmol) | (%) | (%) | Remarks |
| 17 | 10.0 | 5.0 | 400 | 200 | 37 | 6.2 | Whiter powder |
| 18 | 10.0 | 5.0 | 400 | 300 | 30 | 8.7 | Whiter powder |
| 19 | 10.0 | 5.0 | 400 | 400 | 26 | 12.6 | Whiter powder |
| 20 | 10.0 | 5.0 | 200 | 400 | 18 | 16.4 | Viscose liquid |

### Examples 21-24

### Synthesis of VDF/HFP Copolymers Containing A Terminal (C₂H₅O)₃Si Group

A series of (C₂H₅O)₃Si Group terminated VDF/HFP copolymers were prepared by using [(C₂H₅O)₃SiCH₂CH₂]₃B functional initiator (obtained from Example 2). Table 4 summarizes the experimental conditions and results. All polymerization reactions were carried out in a Parr high pressure reactor (200 ml) equipped with a magnetic stir bar. In a typical reaction, 4.6 g of [(C₂H₅O)₃SiCH₂CH₂]₃B (10 mmol) was dissolved in 80 ml of CH₂Cl₂ in a dry box, the reactor was then connected to a vacuum line, and 25.6 g of VDF (400 mmol) and 60 g of HFP (400 mmol) was condensed under vacuum by liquid nitrogen. About 5 mmol O₂ was charged into the reactor to oxidize borane moiety and initiate the polymerization that was carried out at 60° C. for 10 hours. After cooling down to room temperature and releasing the pressure, the mixture was transferred into a flask containing 100 ml of hexane. After stirring for 30 min, the polymer powder was filtered, washed, and then dried under vacuum at 60° C. for 6 hours. About 24 g of polymer (white soft wax) was obtained with yield of 28%. The polymer structure was confirmed by ¹H and ¹⁹F NMR spectra.

TABLE 4
Summary of PVDF Polymers Containing
A Terminal (C₂H₅)₃OSi Group
Prepared by [(C₂H₅O)₃SiCH₂CH₂]₃B/O₂ Initiator

| | | | | | | HFP | |
|---|---|---|---|---|---|---|---|
| | B | O₂ | VDF | HFP | Yield | (% | |
| Ex. | (mmol) | (mmol) | (mmol) | (mmol) | (%) | mol) | Remark |
| 21 | 10.0 | 5.0 | 400 | 200 | 40 | 6.8 | Whiter powder |
| 22 | 10.0 | 5.0 | 400 | 300 | 33 | 9.2 | Whiter powder |
| 23 | 10.0 | 5.0 | 400 | 400 | 28 | 13.0 | Hard wax |
| 24 | 10.0 | 5.0 | 200 | 400 | 17 | 17.2 | viscose |

### Example 25

### Preparation of PVDF/Clay Nanocomposite Using PVDF-t-Si Interfacial Agent

The silane terminated PVDF polymers (PVDF-t-Si), obtained from Examples 3-10, were used as interfacial agents in the preparation of exfoliated PVDF/clay nanocomposites by melt blending process. In a typical example, a PVDF-t-Si polymer containing a terminal C₂H₅OSi(CH₃)₂ group (Tm=168° C., Mn=40,000 g/mol) was mixed with Na⁺-mmt clay, which has an ion-exchange capacity of ca. 90 mequiv/100 g (WM). Static melt intercalation was employed by firstly mixing and grinding PVDF-t-Si dried powder and Na⁺-mmt with 90/10 weight ratio in a mortar and pestle at ambient temperature. The XRD pattern (shown in FIG. 2a) of this simple mixture shows a (001) peak at 20˜7, corresponding to Na⁺-mmt interlayer structure with a d-spacing of 1.45 nm. The mixed powder was then heated at 190° C. for 3 hr under nitrogen condition. The resulting PVDF-t-Si/Na⁺-mmt nanocomposite shows a featureless XRD pattern (shown in FIG. 2b), indicating the formation of an exfoliated clay structure.

The resulting binary PVDF-t-Si/Na⁺-mmt exfoliated nanocomposite was further melting mixing (50/50 weight ratio) with commercial neat PVDF (Mn=70,000 and Mw=180,000 g/mmol). Firstly the PVDF-t-Si/Na⁺-mmt exfoliated nanocomposite and neat PVDF with 50/50 weight ratio were ground together in a mortar and pestle at ambient temperature. The mixed powder was then heated at 200° C. for 3 hr under nitrogen condition. The resulting ternary PVDF/PVDF-t-Si/Na⁺-mmt nanocomposite also shows a featureless XRD pattern (shown in FIG. 2c), indicating that the stable exfoliated structure in the binary PVDF-t-Si/Na⁺-mmt exfoliated nanocomposite is clearly maintained after further mixing with PVDF that is compatible with the backbone of PVDF-t-Si.

### Example 26

### Preparation of PVDF/Clay Nanocomposite Using PVDF-t-Si Interfacial Agent

The silane terminated PVDF polymers (PVDF-t-Si), obtained from Examples 11-16, were used as interfacial agents in the preparation of exfoliated PVDF/clay nanocomposites by melt blending process. In a typical example, a PVDF-t-Si polymer containing a terminal (C₂H₅O)₃Si group (Tₘ=170° C., Mn=30,000 g/mol) was mixed with Na⁺-mmt clay. Static melt intercalation was employed by heating the mixture of PVDF-t-Si and Na⁺-mmt with 90/10 weight ratio at 190° C. for 3 hr under nitrogen condition. The resulting PVDF-t-Si/Na⁺-mmt nanocomposite shows a featureless XRD pattern, indicating the formation of an exfoliated clay structure. The resulting binary PVDF-t-Si/Na⁺-mmt exfoliated nanocomposite was further melting mixing (50/50 weight ratio) with commercial neat PVDF (Mn=70,000 and Mw=180,000 g/mol). The resulting ternary PVDF/PVDF-t-Si/Na⁺-mmt nanocomposite also shows a featureless XRD pattern.

### Example 27

### Synthesis of 8-boraindane

Under Ar atmosphere at 0° C., 21.6 g (0.2 mol) of 1,3,7-octatriene in 50 ml of THF solution was added dropwise with 200 ml (1.0 M) of borane THF complex in THE solution. After the addition was complete, stirring continued for 1 hour at 0° C. Then the mixture was refluxed for 1 hour before THF was removed completely under vacuum at room temperature. The attained white solid was heated to 210° C. for 3 hours then 9.6 g of 9-bora-indane (yield: 41%) was distilled from the mixture at about 50° C. to 60° C. (0.3 mmHg).

### Examples 28-30

### Synthesis of Telechelic Poly(trifluoroethyl acrylate) with Two Terminal OH Groups Using 8-Bora-indane/O₂ Initiator

In a 150 ml flame-dried flask, 40 ml of THF, 5 ml of 2′,2′,2′-trifluoroethyl acrylate (TFEA) monomer, and 70 mg of 8-bora-indane were introduced under argon. After injecting 5 ml of O₂, the solution was mixed by shaking the flask vigorously for about 5 minutes. The solution was then kept at room temperature for various times (2 hr, 4 hr, 6 hr, 8 hr, and 10 hr, respectively) before exposing the solution to air that stops the reaction and oxidized all borane moieties. The polymer solution was then poured into 200 ml of well stirred methanol to precipitate the polymer. The precipitated telechelic poly(trifluoroethyl acrylate) was collected, washed, and dried in vacuum at 60° C. for 2 days, then was characterized by GPC, and ¹H and ¹³C NMR measurements. All the experimental results for the series of examples are summarized in Table 5.

TABLE 5
A summary of TFEA polymerization by 8-bora-indane/O₂ in THF

| | | | | Mw | PDI |
|---|---|---|---|---|---|
| Ex. | Time (hr) | Conversion (%) | Mn (g/mole) | (g/mole) | (Mw/Mn) |
| 28 | 2.0 | 12.0 | 7,000 | 12,000 | 1.8 |
| 29 | 6.0 | 40.0 | 25,000 | 49,000 | 1.9 |
| 30 | 10 | 60.0 | 33,000 | 56,000 | 1.6 |

### Example 31

### Preparation of PTFEA-t-OH/Clay Nanocomposite

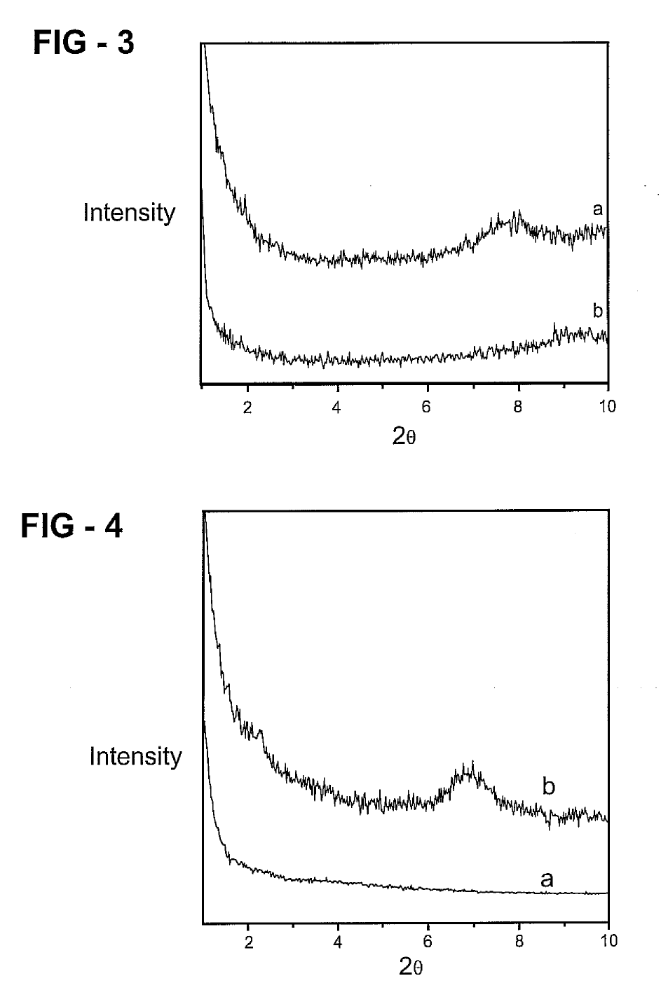

The telechelic poly(trifluoroethyl acrylate) polymer containing two terminal OH groups (PTFEA-t-OH), obtained from Example 30, was mixed with Na⁺-mmt clay, which has an ion-exchange capacity of ca. 90 mequiv/100 g (WM). Static melt intercalation was employed by firstly mixing and grinding PTFEA-t-OH dried powder and Na⁺-mmt with 90/10 weight ratio in a mortar and pestle at ambient temperature. The XRD pattern (shown in FIG. 3a) of this simple mixture shows a (001) peak at 2θ˜7, corresponding to Na⁺-mmt interlayer structure with a d-spacing of 1.45 nm. The mixed powder was then heated at 150° C. for 3 hr under nitrogen condition. The resulting PVDF-t-Si/Na⁺-mmt nanocomposite shows a featureless XRD pattern (shown in FIG. 3b), indicating the formation of an exfoliated clay structure.

### Example 32

### Preparation of PVDF/Na⁺-mmt Clay Nanocomposite by in-situ Polymerization Using Potassium Persulfate Initiator

In a 25 ml flask, 0.10 g of Na⁺-mmt clay and 0.10 g potassium persulfate were dispersed in 2 ml of de-ionized water. The obtained dispersion was charged into a 75 ml stainless steel reactor which contained a magnetic stirring bar and 30 ml of acetonitrile. Then, 20 g of VDF monomer was condensed from high-vacuum line into the reactor, which was subsequently warmed up to room temperature and put in a heated oil bath at 80° C. for 8 hour. After the solvent was evaporated, 6.7 g of polymer (Mₙ=52,500 g/mol, PDI=2.0) was obtained with a yield of 34% and clay weight ratio of 1.5%. The dried product was ground in a mortar and pestle at ambient temperature. A featureless XRD pattern (FIG. 4 , a) was obtained, indicating the formation of an exfoliated clay structure.

### Example 33

### Preparation of PVDF/Na⁺-mmt Clay Nanocomposite by in-situ Polymerization Using H₂O₂ Initiator

In a 25 ml flask, 0.15 ml of H₂O₂ (50 weight % in water) was mixed with 0.20 g of Na⁺-mmt clay in 2 ml of de-ionized water. The obtained dispersion was charged into a 75 ml stainless steel reactor which contained a magnetic stirring bar and 30 ml of acetonitrile. Then, 20 g of VDF monomer was condensed from high-vacuum line into the reactor, which was subsequently warmed up to room temperature and put in a heated oil bath at 110° C. for 3 hour. After the solvent was evaporated, 6 g of polymer was obtained and clay weight ratio of 3.3%. The dried product was ground in a mortar and pestle at ambient temperature. A featureless XRD pattern was observed, indicating the formation of an exfoliated clay structure.

### Example 34

### Preparation of PVDF/Na⁺-mmt Clay Nanocomposite by in-situ Polymerization Using Benzoyl Peroxide Initiator

In a 25 ml flask, 0.10 g of Na⁺-mmt clay and 0.106 g of benzoyl peroxide initiator were dispersed in 2 ml of de-ionized water. The obtained dispersion was charged into a 75 ml stainless steel reactor which contained a magnetic stirring bar and 30 ml of acetonitrile. Then, 20 g of VDF monomer was condensed from high-vacuum line into the reactor, which was subsequently warmed up to room temperature and put in a heated oil bath at 80° C. for 4 hour. After the solvent was evaporated, 4.55 g of polymer was obtained and clay weight ratio of 2.1%. The dried product was ground in a mortar and pestle at ambient temperature. The XRD pattern of this sample (FIG. 4b) shows a clear (001) peak at 2θ˜7, corresponding to Na+-mmt interlayer structure with a d-spacing of 1.45 nm.

### Example 35

### Preparation of PVDF/2C18-mmt Clay Nanocomposite by in-situ Polymerization Using Potassium Persulfate Initiator

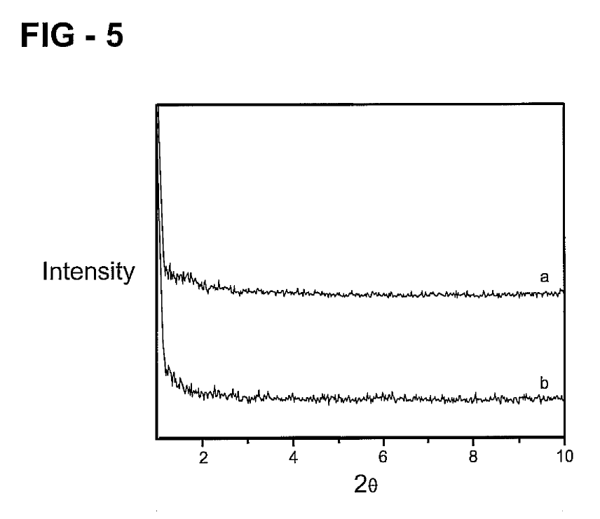

In a 25 ml flask, 0.25 g of 2C18-Montmorillonite clay and 0.10 g potassium persulfate were dispersed in 2 ml of de-ionized water. The obtained dispersion was charged into a 75 ml stainless steel reactor which contained a magnetic stirring bar and 30 ml of acetonitrile. Then 20 g of VDF monomer was condensed from high-vacuum line into the reactor, which was subsequently warmed up to room temperature and put in a heated oil bath at 80° C. for 8 hour. After the solvent was evaporated, 9.8 g of polymer (Mₙ=59,100 g/mol, PDI=2.1) was obtained with a yield of 49% and clay weight ratio of 2.6%. The dried product was ground in a mortar and pestle at ambient temperature. A featureless XRD pattern (FIG. 5, a) was obtained, indicating the formation of an exfoliated clay structure. After the sample was heated at 200° C. for 3 hours, the same featureless XRD pattern (FIG. 5, b) was observed, indicating thermodynamically stable exfoliated structure.

Any patents or publications mentioned in this specification are incorporated herein by reference to the same extent as if each individual publication is specifically and individually indicated to be incorporated by reference. In particular, U.S. Provisional Patent Application Ser. No. 60/795,455, filed Apr. 27, 2006 is incorporated herein by reference in its entirety.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

I claim:

1. An exfoliated fluoropolymer/clay nanocomposite, the nanocomposite comprising:
a reaction product of a layered silicate clay and a chain end functionalized fluoropolymer, where the chain end functionalized fluoropolymer has the formula:
X-(M)ₙ-Y (I)
where M is selected from the group consisting of: one or more types of fluoromonomer unit and a combination of one or more types of fluoromonomer unit and one or more types of hydrocarbon monomer unit; where X and Y are each independently H or a functional group capable of binding to the clay, where at least one of X and Y is a functional group capable of binding to the layered silicate clay; and where n is an integer in the range of about 50 to 50,000, inclusive.

2. The exfoliated fluoropolymer/clay nanocomposite of claim 1 further comprising a component selected from the group consisting of: a neat polymer, an additive, and a combination thereof.

3. The exfoliated fluoropolymer/clay nanocomposite of claim 1, wherein the exfoliated fluoropolymer/clay nanocomposite is characterized by a featureless X-ray diffraction pattern.

4. The exfoliated fluoropolymer/clay nanocomposite of claim 1 where at least one of X and Y is a functional group selected from the group consisting of: Si(R)ₙ(OH)₃₋ₙ, Si(R)ₙ(OR)₃₋ₙ, OH, NH₂, COOH, an anhydride, an ammonium, an imidazolium, a sulfonium, and a phosphonium, where n is 0 to 2, and R is a C₁-C₆ alkyl group.

5. The exfoliated fluoropolymer/clay nanocomposite of claim 1, wherein the fluoromonomer unit is selected from the group consisting of: vinyl fluoride (VF), vinylidine fluoride (VDF), trifluoroethylene (TrFE), tetrafluoroethylene (TFE), hexafluoropropene (HFP), 1-chloro-1-fluoro-ethylene(1,1-CFE), 1-chloro-2-fluoro-ethylene(1,2-CFE), 1-chloro-2,2-difluoroethylene (CDFE), chlorotrifluoroethylene (CTFE), a fluoroalkyl vinyl ether, a perfluoroalkyl vinyl ether, perfluoromethyl vinyl ether (PMVE), perfluoropropyl vinyl ether (PPVE), a fluoroacrylate, a perfluoroacrylate, a perfluoromethacrylate, 2,2,2-trifluoroethyl acrylate, and 2-(perfluorohexyl)ethyl acrylate.

6. The exfoliated fluoropolymer/clay nanocomposite of claim 1 wherein the hydrocarbon monomer unit is selected from the group consisting of: a vinyl chloride, a vinyl ether, an acrylate and a methacrylate.

7. The exfoliated fluoropolymer/clay nanocomposite of claim 1, wherein the layered silicate clay is selected from phyllosilicate clays, layered silicates, and layered fiber silicates, including montmorillonite, nontronite, beidellite, hectorite, saponite, sauconite, vermiculite, ledikite, magadiite, kenyaite, fluoromica, fluorohectorite, attapulgite, boehmite, imogolite, sepiolite, kaolinite, kadinite, a synthetic equivalent, and a combination thereof.

8. The exfoliated fluoropolymer/clay nanocomposite of claim 1, wherein the layered silicate clay is an organophilic clay.

9. The exfoliated fluoropolymer/clay nanocomposite of claim 1, wherein the layered silicate clay is an acidic clay.

10. The exfoliated fluoropolymer/clay nanocomposite of claim 1, where the chain-end functionalized fluoropolymer comprises PVDF, and wherein at least one of X and Y is a terminal functional group selected from the group consisting of OH, Na⁺SO₄⁻, and Si(OR)₃, where R is a C₁-C₆ alkyl group.

11. The exfoliated fluoropolymer/clay nanocomposite of claim 1, wherein the chain-end functionalized fluoropolymer comprises a copolymer selected from the group consisting of: VDF/TFE and VDF/TrFE, the copolymer having a VDF content between 1 and 50 mole %, and where at least one of X and Y is a terminal functional group selected from the group consisting of: OH, Na⁺SO₄⁻, and Si(OR)₃, where R is a C₁-C₆ alkyl group.

12. The exfoliated fluoropolymer/clay nanocomposite of claim 1, wherein the chain-end functionalized fluoropolymer comprises a VDF/HFP fluoro-elastomer having HFP content between 10-25 mole %, and where at least one of X and Y is a terminal functional groups selected from the group consisting of: OH, Na⁺SO₄⁻, and Si(OR)₃, where R is a C₁-C₆ alkyl group.

13. The exfoliated fluoropolymer/clay nanocomposite of claim 1, wherein the chain-end functionalized fluoropolymer comprises a VDF/TFE/HFP fluoro-elastomer having TFE content between 1 and 30 mole %, HFP content between 10-25 mole %, and where at least one of X and Y is a terminal functional groups selected from the group consisting of: OH, Na⁺SO₄⁻, and Si(OR)₃, where R is a C₁-C₆ alkyl group.

14. The exfoliated fluoropolymer/clay nanocomposite of claim 1, wherein the chain-end functionalized fluoropolymer comprises a VDF/TrFE/CTFE terpolymer having TrFE content between 10 and 50 mole %, CTFE content between 1-20 mole %, and wherein at least one of X and Y is a terminal functional groups selected from the group consisting of OH, Na⁺SO₄⁻, and Si(OR)₃, where R is a C₁-C₆ alkyl group.

15. The exfoliated fluoropolymer/clay nanocomposite of claim 1, wherein the chain-end functionalized fluoropolymer comprises a VDF/TrFE/CDFE terpolymer having TrFE content between 10 and 50 mole %, CDFE content between 1-20 mole %, and wherein at least one of X and Y is a terminal functional groups selected from the group consisting of: OH, Na⁺SO₄⁻, and Si(OR)₃, where R is a C₁-C₆ alkyl group.

16. The exfoliated fluoropolymer/clay nanocomposite of claim 1, wherein the chain-end functionalized fluoropolymer comprises a VDF/TrFE/CFE terpolymer having TrFE content between 10 and 50 mole %, CUE content between 1-20 mole %, and wherein at least one of X and Y is a terminal functional groups selected from the group consisting of: OH, Na⁺SO₄⁻, and Si(OR)₃, where R is a C₁-C₆ alkyl group.

17. The exfoliated fluoropolymer/clay nanocomposite of claim 1, wherein the chain-end functionalized fluoropolymer comprises poly(2,2,2-trifluoroethyl acrylate) and wherein at least one of X and Y is a terminal functional groups selected from the group consisting of: OH, Na⁺SO₄⁻, and Si(OR)₃, where R is a C₁-C₆ alkyl group.

18. The exfoliated fluoropolymer/clay nanocomposite of claim 1, wherein the chain-end functionalized fluoropolymer comprises poly(2-perfluorohexyl ethyl acrylate) and wherein at least one of X and Y is a terminal functional groups selected from the group consisting of: OH, Na⁺SO₄⁻, and Si(OR)₃, where R is a C₁-C₆ alkyl group.

19. The exfoliated fluoropolymer/clay nanocomposite of claim 1, wherein the layered silicate clay is present in an amount in the range of about 1 to 20 parts by weight of the total weight of the nanocomposite, and wherein the chain end functionalized fluoropolymer is present in an amount in the range of about 5 to 98 parts by weight of the total weight of the nanocomposite.

20. The exfoliated fluoropolymer/clay nanocomposite of claim 19 further comprising a neat polymer, wherein the neat polymer is present in an amount in the range of about 0.1 to 95 parts by weight of the total weight of the nanocomposite and wherein the neat polymer is miscible with the chain end functionalized fluoropolymer.

21. A process for producing an exfoliated fluoropolymer/clay nanocomposite, comprising: reacting a chain-end functionalized fluoropolymer and a layered silicate clay thereby producing an exfoliated fluoropolymer/clay nanocomposite.

22. The process of claim 21 wherein the reacting includes a process selected from: a melt process and a solution process.

23. The process of claim 21 further comprising blending the exfoliated fluoropolymer/clay nanocomposite with a neat polymer.

24. The process of claim 21 further comprising blending the exfoliated fluoropolymer/clay nanocomposite with an additive.

25. The process of claim 24 wherein the additive is selected from the group consisting of: a pigment, a dye, a stabilizer, a filler, an antioxidant, a viscosity modifier, a releasing agent, an electrical conductivity modifier, and a combination of any of these.

26. An in situ process for producing an exfoliated fluoropolymer/clay nanocomposite, comprising: reacting a fluoromonomer, a functionalized radical initiator, and a layered silicate clay, thereby producing an exfoliated fluoropolymer/clay nanocomposite.

27. The process of claim 26 further comprising blending the exfoliated fluoropolymer/clay nanocomposite with a neat polymer.

28. The process of claim 26 further comprising blending the exfoliated fluoropolymer/clay nanocomposite with an additive.

29. The process of claim 28 wherein the additive is selected from the group consisting of: a pigment, a dye, a stabilizer, a filler, an antioxidant, a viscosity modifier, a releasing agent, an electrical conductivity modifier, and a combination of any of these.
